(19) United States
(12) Patent Application Publication
(10) Pub. No.: US 2025/0328887 A1
(43) Pub. Date: Oct. 23, 2025

(54) MULTI-MODAL DATA DISTRIBUTION IN AN INFORMATION PROCESSING SYSTEM

(71) Applicant: Dell Products L.P., Round Rock, TX (US)

(72) Inventors: Sisir Samanta, Austin, TX (US); Shibi Panikkar, Bangalore (IN)

(21) Appl. No.: 18/642,366

(22) Filed: Apr. 22, 2024

(51) Int. Cl. G06Q 20/22

(52) U.S. Cl. CPC G06Q 20/29

(57) ABSTRACT

Data management techniques for multi-modal data distribution in information processing systems are disclosed. For example, a method computes, at a first processing node of an information processing system in accordance with a subscription model managed by the first processing node, a variance in an attribute of the subscription model with respect to a second processing node of the information processing system. The method receives, at the first processing node from the second processing node, a selection of a variance distribution mode from a plurality of variance distribution modes. The method applies, at the first processing node, the selected variance distribution mode to the attribute of the subscription model.

### FIELD

The field relates generally to information processing systems, and more particularly to techniques for data management in such information processing systems.

### BACKGROUND

Current digital commerce systems, e.g., information processing systems configured to enable buyers (e.g., customers) and sellers (e.g., manufacturers/vendors) to conduct transactions over a computer network, have the power to enable sellers to understand buyers and their sentiments, and enable buyers to order items from sellers without human assistance (e.g., automated online transactions). On the seller side (e.g., enterprises such as an original equipment manufacturer or OEM), current digital commerce systems allow an enterprise to understand the customers' specific requirements and enables customer transactions with customized initial conditions, i.e., executed automatically via the digital commerce system. Subsequent custom conditions are typically provided in digital commerce systems with respect to recurring transactions. However, over time, discrepancies can occur within the digital commerce system between initial transaction conditions and recurring transaction conditions.

Such transaction condition-based discrepancies cause technical issues with respect to resources of the underlying distributed computer network on which the digital commerce system resides and executes. For example, computer processing delays, data storage shortages, and/or communication network congestion occurs, especially when automated resolutions of such discrepancies cause additional resources in the digital commerce system to be needed.

### SUMMARY

Illustrative embodiments provide data management techniques for multi-modal data distribution in information processing systems. While techniques illustratively described herein are particularly well-suited for digital commerce systems, the data management techniques are more broadly applicable to a wide variety of other information processing systems.

For example, in one or more illustrative embodiments, a method computes, at a first processing node of an information processing system in accordance with a subscription model managed by the first processing node, a variance in an attribute of the subscription model with respect to a second processing node of the information processing system. The method receives, at the first processing node from the second processing node, a selection of a variance distribution mode from a plurality of variance distribution modes. The method applies, at the first processing node, the selected variance distribution mode to the attribute of the subscription model.

These and other illustrative embodiments include, without limitation, methods, apparatus, networks, systems and processor-readable storage media.

### BRIEF DESCRIPTION OF THE DRAWINGS

FIG. 1 illustrates an information processing system in which multi-modal data distribution functionalities according to one or more illustrative embodiments can be implemented.

FIG. 2 illustrates an example of a data definition associated with a subscription model according to an illustrative embodiment.

FIG. 3 illustrates an example of a data store associated with the data definition of FIG. 2.

FIGS. 4A through 4C illustrate a first data distribution mode according to an illustrative embodiment.

FIGS. 5A through 5C illustrate a second data distribution mode according to an illustrative embodiment.

FIGS. 6A through 6C illustrate a third data distribution mode according to an illustrative embodiment.

FIGS. 7A through 7C illustrate a fourth data distribution mode according to an illustrative embodiment.

FIG. 8 illustrates a multi-modal data distribution methodology for use in a digital commerce system according to an illustrative embodiment.

FIGS. 9 and 10 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, processing systems comprising compute, storage and/or network resources, other types of processing systems comprising various combinations of physical and/or virtual resources, as well as other types of distributed computer networks.

As mentioned, existing digital commerce systems, over time, can experience discrepancies between initial transaction conditions and recurring transaction conditions. By way of example only, consider a digital commerce system wherein an OEM offers information technology (IT) products and services to a customer. In some examples, the IT products and services can include computing, storage, and/or network equipment (e.g., servers, storage arrays, routers, switches, etc.) that the customer may use to run their own enterprise. In some further examples, while the OEM sells or leases an initial IT configuration to the customer for deployment at the customer's site, enterprise growth experienced by the customer may necessitate additional equipment being sold/leased and deployed or otherwise made available at the customer's site. In yet further examples, equipment can be offered via the digital commerce system to a customer as part of a subscription model. In the subscription model, the customer would receive an IT configuration for an initial payment and would add equipment over time, as needed or otherwise scheduled, in accordance with a recurring payment plan. This arrangement is also sometimes referred to as an Infrastructure-as-a-Service (IaaS) subscription. Oftentimes, in such a subscription model, the OEM can offer discounts and promotional pricing to the customer based on a record of previous equipment needs and payment history.

However, while the OEM embraces the automated digital experience to satisfy customer demand and build a high trust relationship, such subscription models automatically implemented in digital commerce systems can suffer from a data discrepancy issue. For example, a price rounding issue, as will be illustratively described below, can occur within the digital commerce system leading to a difference between the price committed in the initial sale and the price that is recurringly billed. Thus, while in a standard sales process a rounding issue with a custom price and a custom discount might not be significantly notable because pricing and billing is done just once per sales order, a small rounding difference may have a significant impact for subscription and IaaS-based sales since, in the latter case, pricing and billing is done multiple times throughout the contract duration of the subscription. Among other technical issues, this data discrepancy can lead to a significant increase in communications over the digital commerce system between the OEM and the customer in terms of explanation and resolution resulting in technical issues with respect to resources of the underlying distributed computer network on which the digital commerce system resides and executes. For example, computer processing delays, data storage shortages, and/or communication network congestion occurs, especially when automated resolutions of such discrepancies cause additional resources in the digital commerce system to be needed.

Illustrative embodiments overcome the above and other technical issues by providing data management techniques for multi-modal data distribution in information processing systems. While techniques illustratively described herein are particularly well-suited for digital commerce systems, the data management techniques are more broadly applicable to a wide variety of other information processing systems.

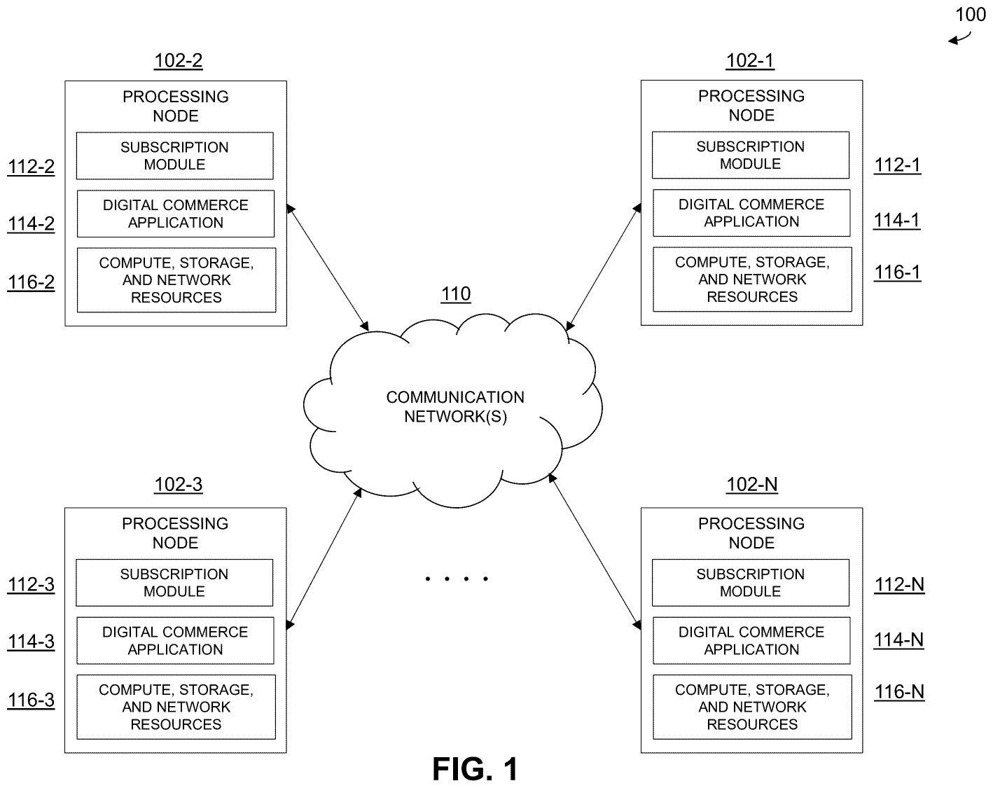

FIG. 1 illustrates an information processing system 100 in which multi-modal data distribution functionalities according to one or more illustrative embodiments can be implemented. As shown, information processing system 100 includes processing nodes 102-1, 102-2, 102-3, . . . , 102-N (may hereinafter each individually be referred to as processing node 102 or collectively as processing nodes 102). Processing nodes 102 are operatively coupled to one another via one or more communication networks 110.

Processing node 102-1 comprises a subscription module 112-1, a digital commerce application 114-1, and a set of compute, storage, and network resources 116-1. Processing node 102-2 comprises a subscription module 112-2, a digital commerce application 114-2, and a set of compute, storage, and network resources 116-2. Processing node 102-3 comprises a subscription module 112-3, a digital commerce application 114-3, and a set of compute, storage, and network resources 116-3. Processing node 102-N comprises a subscription module 112-N, a digital commerce application 114-N, and a set of compute, storage, and network resources 116-N.

Subscription modules 112-1, 112-2, 112-3, . . . , 112-N may hereinafter each individually be referred to as subscription module 112 or collectively as subscription modules 112. Digital commerce applications 114-1, 114-2, 114-3, . . . , 114-N may hereinafter each individually be referred to as digital commerce application 114 or collectively as digital commerce applications 114. Sets of compute, storage, and network resources 116-1, 116-2, 116-3, . . . , 116-N may hereinafter each individually be referred to as set of compute, storage, and network resources 116 or collectively as sets of compute, storage, and network resources 116.

In some embodiments, information processing system 100 may be considered a digital commerce system. By way of example only, in the above-mentioned OEM/customer IT subscription model, assume one of processing nodes 102 is associated with the OEM and the other processing nodes 102 are respectively associated with customers. While digital commerce application 114 running on each processing node 102 provides general digital commerce functions (e.g., user interface, product/service offerings, product/service selection, etc.), assume that subscription module 112 in each processing node 102 manages the subscription model functions (e.g., subscription terms including, but not limited to, initial and recurring pricing). Thus, assuming processing node 102-1 is associated with the OEM and processing node 102-2 is associated with a first customer, subscription module 112-1 in processing node 102-1 would enable the OEM to set and/or adjust subscription pricing conditions, which would then be communicated to the first customer via subscription module 112-2 in processing node 102-2. Further, sets of compute, storage, and network resources 116 may then collectively comprise what is mentioned herein as the resources of the underlying computer system upon which the digital commerce system resides and executes.

In one non-limiting example to illustrate the above-mentioned price rounding issue in the subscription-based recurring scenario, assume the OEM is offering a subscription price in different contract term options (e.g., 1/3/5 years), and the first customer selected 1 year (i.e., 12 month) with monthly billing for 20 units (e.g., units can be whatever type of equipment for which the customer is contracting). Further assume the original unit price ($) per month is 19.29, so the total contract price will be calculated as 19.29*12*20=4629.60. Still further, assume that the contract includes an 8 percent discount on the total contract price, making the discounted total contract price 4259.23. However, the actual discounted value is 4259.232. A reverse calculation by division is performed to derive the monthly unit price as 4259.23/(12*20) which is 17.75 with 2 decimal places rounding. The monthly billing amount is thus 355 (17.75*20). The total billed amount for the entire contract is thus 4260 (335*12). As such, a rounding loss of 0.77 occurs (4260−4259.23).

While, in the above simplified example, rounding loss is clearly visible, there are many such cases where simple mathematics will not be able to resolve the rounding issue. Further, it can be very difficult to identify the correct rounding logic and decimal precision of rounding in multiple use cases. In some use cases, the rounding loss is too high and not acceptable by stake holders, and in some cases may be to the advantage of the customer and in other cases to the advantage of the OEM, depending on how rounding logic is applied. To add to the complexity, the policy of rounding may be different across different geographical regions that the digital commerce system spans.

Illustrative embodiments address the above data discrepancy (e.g., price rounding) issue with multi-modal data distribution logic that may be implemented, for example, in subscription module 112-1 of processing node 102-1 (assuming processing node 102-1 is the processing node 102 associated with the OEM) or elsewhere in information processing system 100 as may be appropriate. For example, in some embodiments, such multi-modal data distribution logic is configured to calculate a variance (e.g., data rounding error) and redistribute the variance in one of a plurality of variance normalizing (e.g., equalizing) modes (e.g., front loading mode, mid loading mode, tail loading mode, and uniform mode, which can be selectable by the customer) to achieve zero variance.

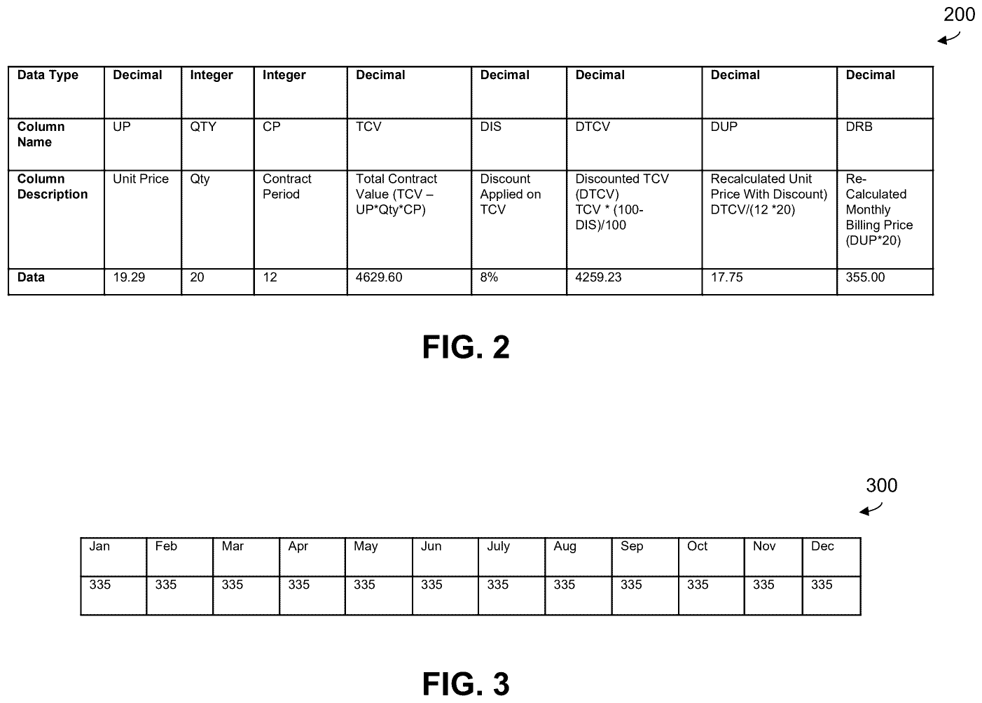

FIG. 2 illustrates a table 200 representing an example of a data definition associated with a subscription model according to an illustrative embodiment. FIG. 3 illustrates a table 300 representing a data store associated with the data definition of FIG. 2.

More particularly, tables 200 and 300 correspond to the non-limiting example wherein the OEM is offering a subscription price and the first customer selects 1 year (i.e., 12 months) with monthly billing for 20 units. Thus, as shown in table 200, UP refers to unit price (19.29), QTY refers to unit quantity (20), CP refers to contract period (12), TCV refers to total contract value (4629.60), DIS refers to discount applied on TCV (8%), DTCV refers to discounted TCV (4259.23), DUP refers to recalculated unit price with discount (17.75), and DRB refers to recalculated monthly billing price (355). The variance will happen on the DRB column in table 200. Table 300 represents monthly billing for 12 months, 355*12=4260. Variance reference column is DTCV (discounted total value) which is 4259.23. So, the expected variance at the end of one year is 0.77 (4260−4259.23).

In accordance with illustrative embodiments, the affected customer can select, via its corresponding subscription module 112 in processing node 102, a variation (data) distribution from four different variance normalizing modes, as will be illustratively described below.

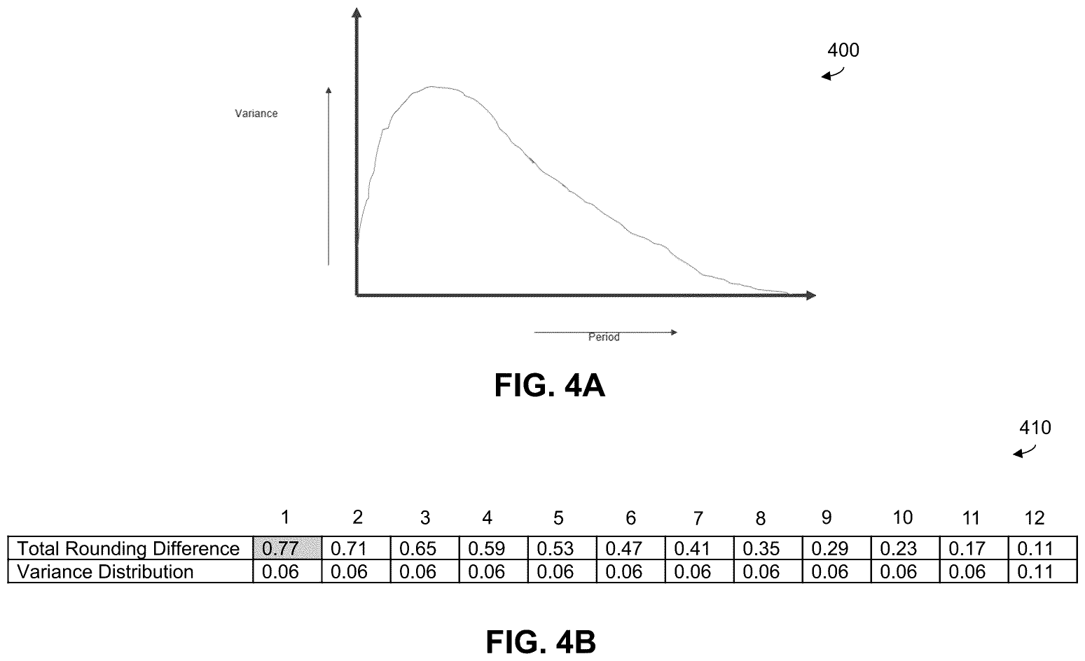

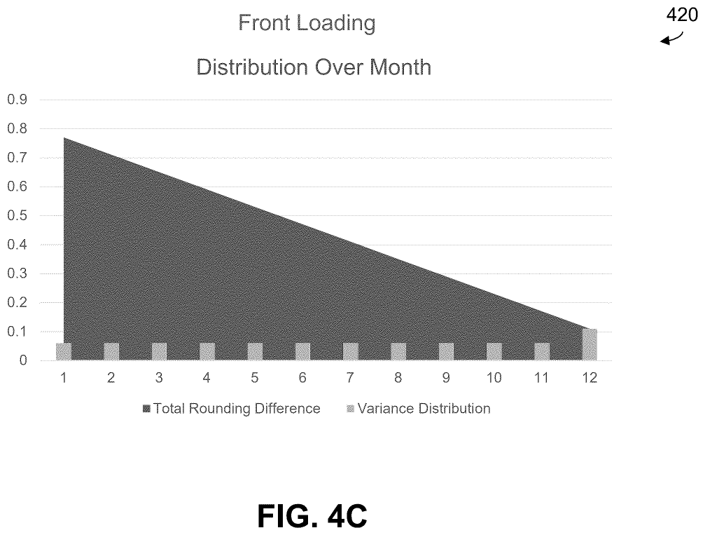

FIGS. 4A through 4C illustrate a first data distribution mode according to an illustrative embodiment. The first data distribution mode is a front loading variance normalizing mode. More particularly, FIG. 4A illustrates a graph 400 showing a plot of variance (0.77) versus contract period (12), while FIG. 4B illustrates a table 410 where the first row is the total rounding difference and the second row is the variance distribution over the 12 month period. Note that the total variance of 0.77 is accounted for in the first 11 months by distributing 0.06 evenly each month with the remainder of 0.11 being accounted for in the last month, thus resulting in a zero variance. FIG. 4C shows a graph 420 of the front loading distribution consistent with the data of table 410.

In some embodiments, first data distribution mode can be implemented by a front loading variance normalizing mode algorithm including:
1. Find the TCV and current billing variation=0.77. In some embodiments, TCV can be represented using a complex number structure, e.g., (x+iy, x+jy, x+ky), while in other embodiments, TCV can be represented as 0-term period.
2. Find the total number of the distribution set, in this example, CP=12.
3. Find the intervals, in this example, the average variance distribution over the billing period. Monthly variation=Variation/CP=0.77/12=0.0641666, and rounded to 0.06 (two decimal rounding).
4. Equal distribute the difference from the front or first set (month 1) to the 11th set (month 11).
5. Find the remainder and adjust in last set (month 12). Thus, (CP−1)*rounded price=(12−1)*0.06=0.66. Then, the 12th month variation=0.77−0.66=0.11.

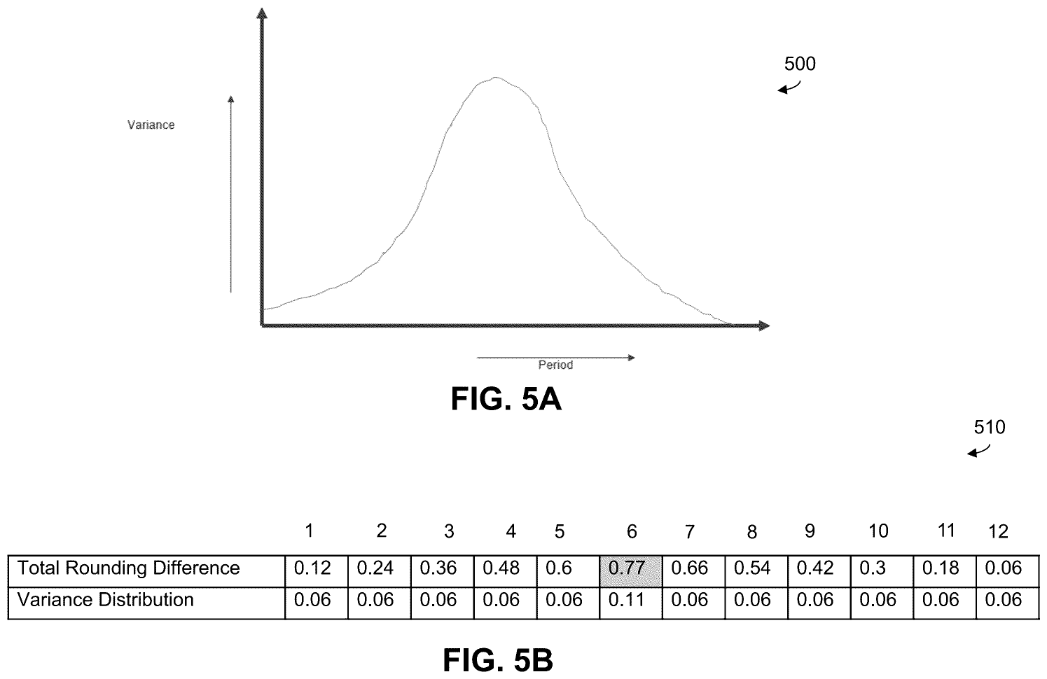

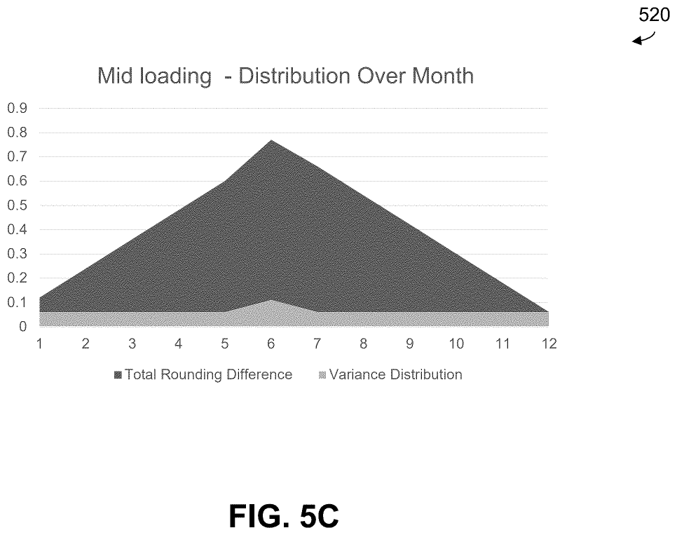

FIGS. 5A through 5C illustrate a second data distribution mode according to an illustrative embodiment. The second data distribution mode is a middle (mid) loading variance normalizing mode. More particularly, FIG. 5A illustrates a graph 500 showing a plot of variance (0.77) versus contract period (12), while FIG. 5B illustrates a table 510 where the first row is the total rounding difference and the second row is the variance distribution over the 12 month period. Note that the total variance of 0.77 is accounted for by distributing 0.06 evenly for the first five months and the last six months. The remainder of 0.11 is accounted for in the sixth (middle) month, thus resulting in a zero variance. FIG. 5C shows a graph 520 of the middle loading distribution consistent with the data of table 510.

In some embodiments, second data distribution mode can be implemented by a middle loading variance normalizing mode algorithm including:
1. Find the TCV and current billing variation=0.77. In some embodiments, TCV can be represented using a complex number structure, e.g., (x+iy, x+jy, x+ky), while in other embodiments, TCV can be represented as 0-term period.
2. Find the total number of the distribution set, in this example, CP=12.
3. Find the intervals, in this example, the average variance distribution over the billing period. Monthly variation=Variation/CP=0.77/12=0.0641666, and rounded to 0.06 (two decimal rounding).
4. Equally distribute the difference before the mid-point and then after the mid-point (e.g., in this case, the sixth month).
5. Find the remainder and adjust: CP*rounded Price=12*0.06−0.72 with the 6th month variation=0.77−0.72=0.06+0.05=0.11.

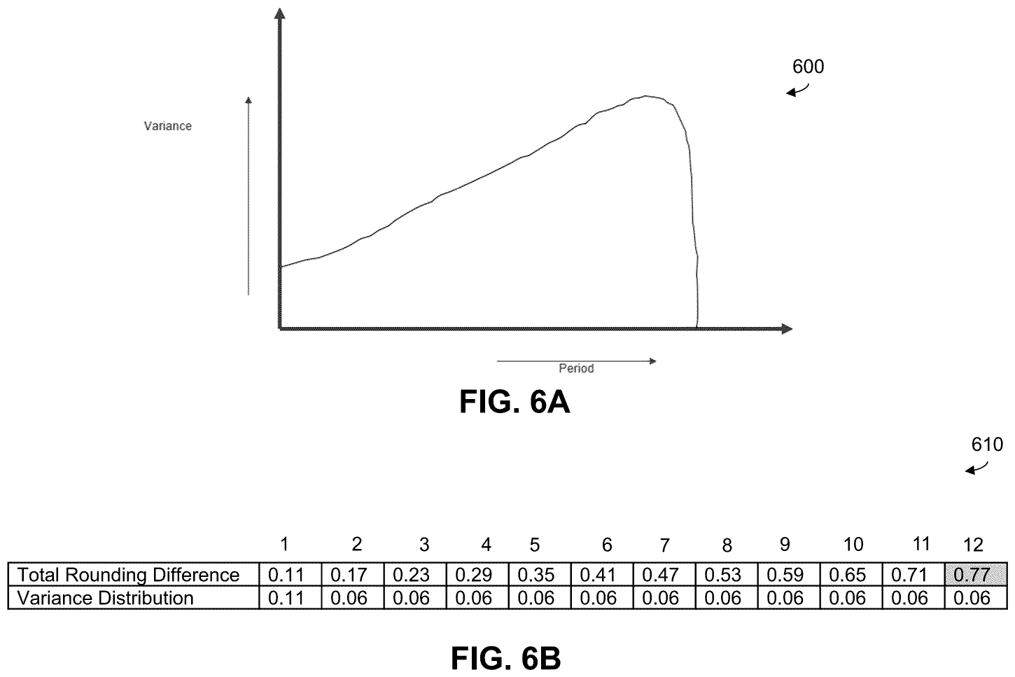

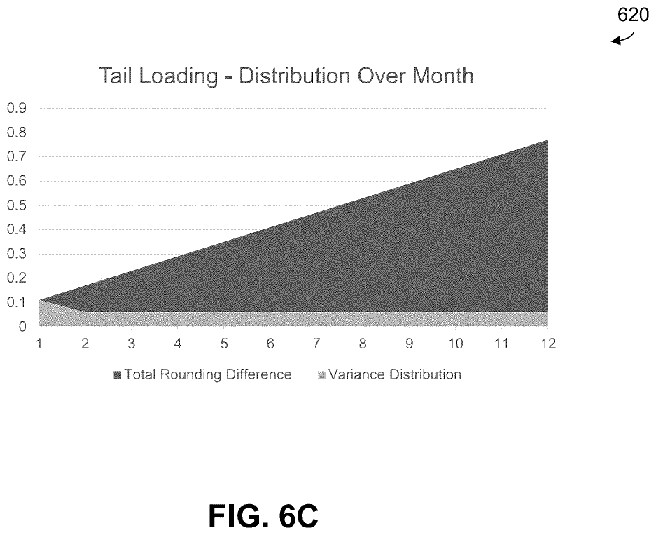

FIGS. 6A through 6C illustrate a third data distribution mode according to an illustrative embodiment. The third data distribution mode is a tail loading variance normalizing mode. More particularly, FIG. 6A illustrates a graph 600 showing a plot of variance (0.77) versus contract period (12), while FIG. 6B illustrates a table 610 where the first row is the total rounding difference and the second row is the variance distribution over the 12 month period. Note that the total variance of 0.77 is accounted for by distributing 0.11 in the first month and then in the remaining 11 months by distributing 0.06 evenly each month, thus resulting in a zero variance. FIG. 6C shows a graph 620 of the tail loading distribution consistent with the data of table 610.

In some embodiments, third data distribution mode can be implemented by a tail loading variance normalizing mode algorithm including:
1. Find the TCV and current billing variation=0.77. In some embodiments, TCV can be represented using a complex number structure, e.g., (x+iy, x+jy, x+ky), while in other embodiments, TCV can be represented as 0-term period.
2. Find the total number of the distribution set, in this example, CP=12.
3. Find the intervals, in this example, the average variance distribution over the billing period. Monthly variation=Variation/CP=0.77/12=0.0641666, and rounded to 0.06 (two decimal rounding).
4. Equally distribute the difference from the tail or last set (month 12) to the second month.
5. Find the remainder and adjust in first set (month 1). Thus, (CP−1)*rounded price=(12−1)*0.06=0.66. Then, the first month variation=0.77−0.66=0.11.

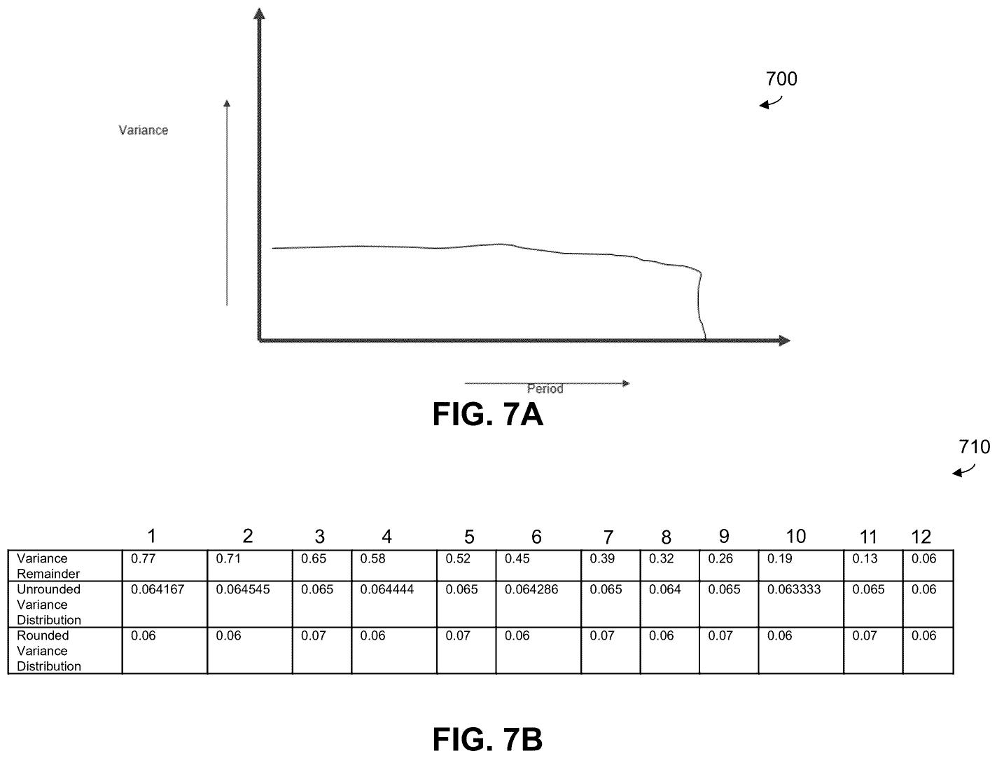

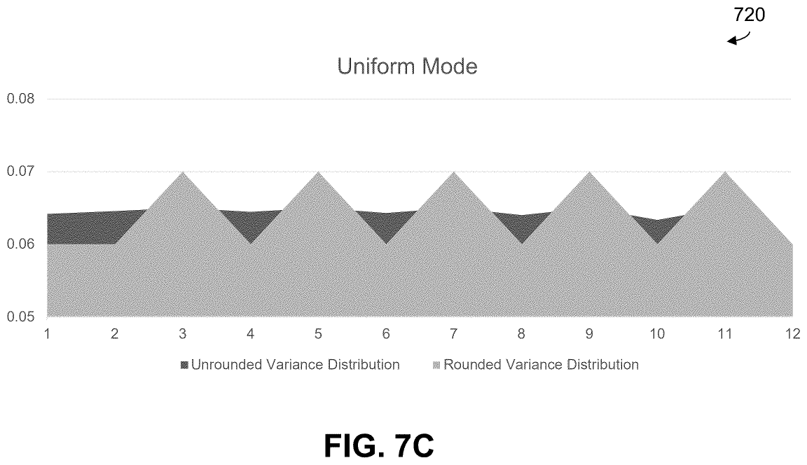

FIGS. 7A through 7C illustrate a fourth data distribution mode according to an illustrative embodiment. The fourth data distribution mode is a uniform loading variance normalizing mode. More particularly, FIG. 7A illustrates a graph 700 showing a plot of variance (0.77) versus contract period (12), while FIG. 7B illustrates a table 710 where the first row is the variance remainder, the second row is the unrounded variance distribution, and the third row is the rounded variance distribution over the 12 month period. Note that the total variance of 0.77 is accounted for by distributing approximately evenly (0.06 or 0.07 each month) for the 12 months, thus resulting in a zero variance. FIG. 7C shows a graph 720 of the uniform loading distribution consistent with the data of table 710.

In some embodiments, fourth data distribution mode can be implemented by a uniform loading variance normalizing mode algorithm including:
1. Find the TCV and current billing variation=0.77. In some embodiments, TCV can be represented using a complex number structure, e.g., (x+iy, x+jy, x+ky), while in other embodiments, TCV can be represented as 0-term period.
2. Find the total number of the distribution set, in this example, CP=12.
3. Find the variance for the first set=TCV/(CP−0)-0.77/12=0.064167.
4. Round the variance value within the nearest two decimal places, i.e., 0.06.
5. Compute remaining TCV variation to distribute=0.77−0.06=0.71, and reset TCV to 0.71 for remaining 11 distribution sets.
6. Repeat steps 1 to 5 for all remaining distribution sets (total set 12, start from 1 to 12).

Advantageously, illustrative embodiments provide a variance definition for decimal data types, rounding methods, and numbers of precisions to recalculate the variance and distribute the difference amongst a total contract length or billing period to keep the rounding difference zero for the total contract amount versus total billing amount. Furthermore, illustrative embodiments provide a plurality of different modes (e.g., front load, mid load, tail load, and uninform) to the system and user to utilize in different use cases for distribution of the variance while still keeping the rounding difference to zero.

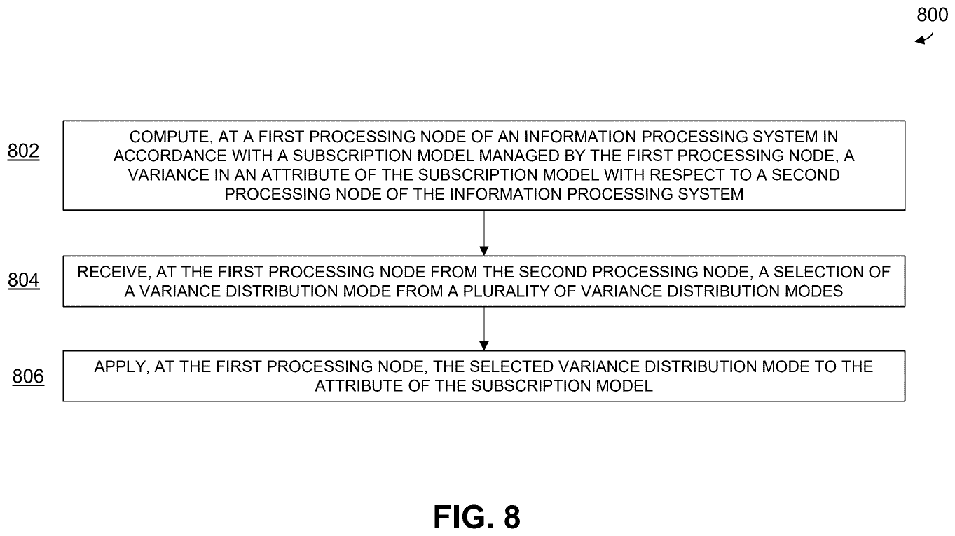

FIG. 8 illustrates a multi-modal data distribution methodology 800 for use in a digital commerce system according to an illustrative embodiment. As shown, step 802 computes, at a first processing node of an information processing system in accordance with a subscription model managed by the first processing node, a variance in an attribute of the subscription model with respect to a second processing node of the information processing system. Step 804 receives, at the first processing node from the second processing node, a selection of a variance distribution mode from a plurality of variance distribution modes. Step 806 applies, at the first processing node, the selected variance distribution mode to the attribute of the subscription model.

In some embodiments, the plurality of variance distribution modes comprise a first variance normalizing mode, a second variance normalizing mode, a third variance normalizing mode, and a fourth variance normalizing mode.

In some embodiments, the first (e.g., front loading) variance normalizing mode further comprises distributing the variance over a plurality of distribution sets such that the variance is evenly distributed from a first distribution set to a second to last distribution set of the plurality of distribution sets, and a remainder of the variance is distributed in a last distribution set of the plurality of distribution sets.

In some embodiments, the second (e.g., middle loading) variance normalizing mode further comprises distributing the variance over a plurality of distribution sets such that the variance is evenly distributed from a first distribution set to a distribution set before a middle distribution set of the plurality of distribution sets, evenly distributed from a distribution set after the middle distribution set to a last distribution set of the plurality of distribution sets, and a remainder of the variance is distributed in the middle distribution set.

In some embodiments, the third (e.g., tail loading) variance normalizing mode further comprises distributing the variance over a plurality of distribution sets such that the variance is evenly distributed from a second distribution set to a last distribution set of the plurality of distribution sets, and a remainder of the variance is distributed in a first distribution set of the plurality of distribution sets.

In some embodiments, the fourth (e.g., uniform loading) variance normalizing mode further comprises distributing the variance over a plurality of distribution sets such that the variance is approximately evenly distributed from a first distribution set to a last distribution set of the plurality of distribution sets.

In some embodiments, the attribute to which the selected variance distribution mode is applied by the first processing node comprises an attribute (e.g., price) rounding error. The attribute rounding error may occur in the subscription model in response to a change in an initial attribute value.

In some embodiments, the information processing system comprises a digital commerce system, and the first processing node is associated with a provider entity (e.g., seller or OEM) in the digital commerce system and the second processing node is associated with a consumer entity (e.g., buyer or customer of OEM) in the digital commerce system.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

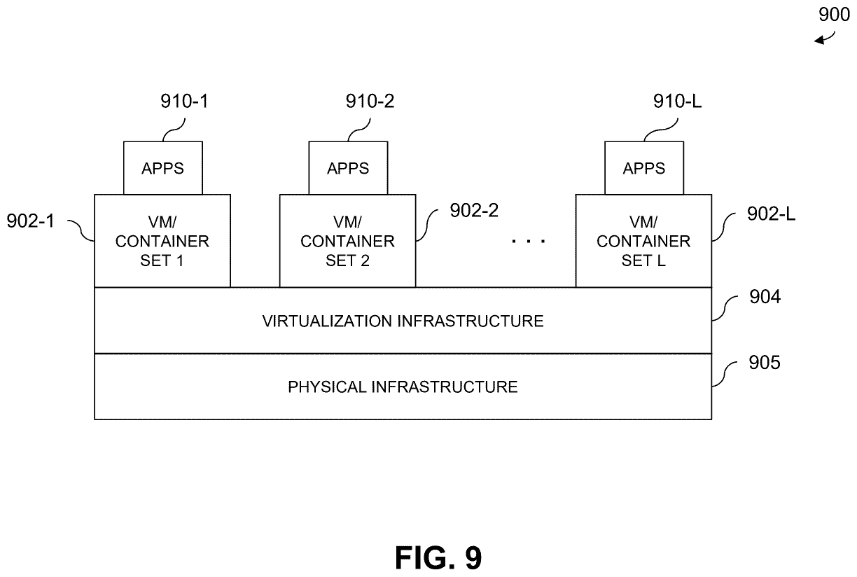

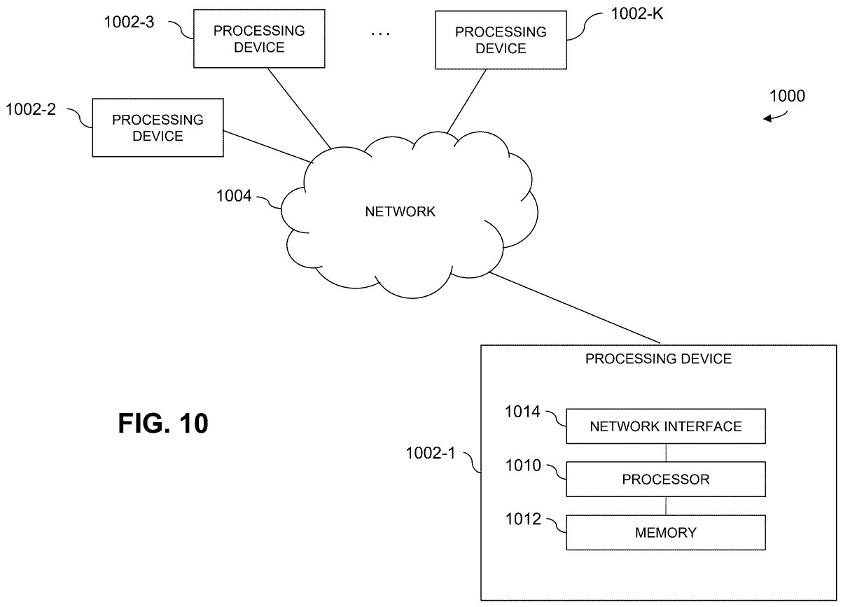

Illustrative embodiments of processing platforms utilized to implement functionality for multi-modal data distribution functionalities will now be described in greater detail with reference to FIGS. 9 and 10. Although described in the context of information processing system environment mentioned herein, these platforms may also be used to implement at least portions of other information processing systems in other embodiments.

FIG. 9 shows an example processing platform comprising infrastructure 900.

Infrastructure 900 comprises a combination of physical and virtual processing resources that may be utilized to implement at least a portion of the information processing system 100 in FIG. 1. Infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

Infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. A hypervisor platform may be used to implement a hypervisor within the virtualization infrastructure 904, where the hypervisor platform has an associated virtual infrastructure management system. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 900 shown in FIG. 9 may represent at least a portion of one processing platform. Another example of such a processing platform is processing platform 1000 shown in FIG. 10.

The processing platform 1000 in this embodiment comprises at least a portion of information processing system 100 and includes a plurality of processing devices, denoted 1002-1, 1002-2, 1002-3, . . . 1002-K, which communicate with one another over a network 1004.

The network 1004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1002-1 in the processing platform 1000 comprises a processor 1010 coupled to a memory 1012.

The processor 1010 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1012 may comprise random access memory (RAM), read-only memory (ROM), flash memory or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and information processing system environments mentioned herein may include additional or alternative processing platforms, as well as numerous distinct processing platforms in any combination, with each such platform comprising one or more computers, servers, storage devices or other processing devices. For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
computing, at a first processing node of an information processing system in accordance with a subscription model managed by the first processing node, a variance in an attribute of the subscription model with respect to a second processing node of the information processing system;
receiving, at the first processing node from the second processing node, a selection of a variance distribution mode from a plurality of variance distribution modes; and
applying, at the first processing node, the selected variance distribution mode to the attribute of the subscription model.

2. The method of claim 1, wherein the plurality of variance distribution modes comprise a first variance normalizing mode, a second variance normalizing mode, a third variance normalizing mode, and a fourth variance normalizing mode.

3. The method of claim 2, wherein the first variance normalizing mode further comprises distributing the variance over a plurality of distribution sets such that the variance is evenly distributed from a first distribution set to a second to last distribution set of the plurality of distribution sets, and a remainder of the variance is distributed in a last distribution set of the plurality of distribution sets.

4. The method of claim 2, wherein the second variance normalizing mode further comprises distributing the variance over a plurality of distribution sets such that the variance is evenly distributed from a first distribution set to a distribution set before a middle distribution set of the plurality of distribution sets, evenly distributed from a distribution set after the middle distribution set to a last distribution set of the plurality of distribution sets, and a remainder of the variance is distributed in the middle distribution set.

5. The method of claim 2, wherein the third variance normalizing mode further comprises distributing the variance over a plurality of distribution sets such that the variance is evenly distributed from a second distribution set to a last distribution set of the plurality of distribution sets, and a remainder of the variance is distributed in a first distribution set of the plurality of distribution sets.

6. The method of claim 2, wherein the fourth variance normalizing mode further comprises distributing the variance over a plurality of distribution sets such that the variance is approximately evenly distributed from a first distribution set to a last distribution set of the plurality of distribution sets.

7. The method of claim 1, wherein the attribute to which the selected variance distribution mode is applied by the first processing node comprises an attribute rounding error.

8. The method of claim 7, wherein the attribute rounding error occurs in the subscription model in response to a change in an initial attribute value.

9. The method of claim 1, wherein the information processing system comprises a digital commerce system.

10. The method of claim 9, wherein the first processing node is associated with a provider entity in the digital commerce system and the second processing node is associated with a consumer entity in the digital commerce system.

11. An apparatus comprising:
a first processing node of an information processing system configured to:
compute, in accordance with a subscription model managed by the first processing node, a variance in an attribute of the subscription model with respect to a second processing node of the information processing system;
receive, from the second processing node, a selection of a variance distribution mode from a plurality of variance distribution modes; and
apply the selected variance distribution mode to the attribute of the subscription model.

12. The apparatus of claim 11, wherein the plurality of variance distribution modes comprise a first variance normalizing mode, a second variance normalizing mode, a third variance normalizing mode, and a fourth variance normalizing mode.

13. The apparatus of claim 12, wherein the first variance normalizing mode further comprises distributing the variance over a plurality of distribution sets such that the variance is evenly distributed from a first distribution set to a second to last distribution set of the plurality of distribution sets, and a remainder of the variance is distributed in a last distribution set of the plurality of distribution sets.

14. The apparatus of claim 12, wherein the second variance normalizing mode further comprises distributing the variance over a plurality of distribution sets such that the variance is evenly distributed from a first distribution set to a distribution set before a middle distribution set of the plurality of distribution sets, evenly distributed from a distribution set after the middle distribution set to a last distribution set of the plurality of distribution sets, and a remainder of the variance is distributed in the middle distribution set.

15. The apparatus of claim 12, wherein the third variance normalizing mode further comprises distributing the variance over a plurality of distribution sets such that the variance is evenly distributed from a second distribution set to a last distribution set of the plurality of distribution sets, and a remainder of the variance is distributed in a first distribution set of the plurality of distribution sets.

16. The apparatus of claim 12, wherein the fourth variance normalizing mode further comprises distributing the variance over a plurality of distribution sets such that the variance is approximately evenly distributed from a first distribution set to a last distribution set of the plurality of distribution sets.

17. The apparatus of claim 11, wherein the attribute to which the selected variance distribution mode is applied by the first processing node comprises an attribute rounding error.

18. The apparatus of claim 17, wherein the attribute rounding error occurs in the subscription model in response to a change in an initial attribute value.

19. The apparatus of claim 11, wherein the information processing system comprises a digital commerce system, and wherein the first processing node is associated with a provider entity in the digital commerce system and the second processing node is associated with a consumer entity in the digital commerce system.

20. A computer program product comprising a non-transitory processor-readable storage medium having stored therein program code of one or more software programs, wherein the program code when executed by a first processing node of an information processing system causes the first processing node to:
compute, in accordance with a subscription model managed by the first processing node, a variance in an attribute of the subscription model with respect to a second processing node of the information processing system;
receive, from the second processing node, a selection of a variance distribution mode from a plurality of variance distribution modes; and
apply the selected variance distribution mode to the attribute of the subscription model.
